(19) United States
(12) Patent Application Publication
(10) Pub. No.: US 2026/0103142 A1
(43) Pub. Date: Apr. 16, 2026

(54) INTEGRATED SIREN AND LIGHT HEAD SYSTEM AND METHOD

(71) Applicant: WHELEN ENGINEERING COMPANY INC., Chester, CT (US)

(72) Inventors: William C. Stuchell, Quaker Hill, CT (US); Jon H. Lyons, Haddam, CT (US)

(73) Assignee: WHELEN ENGINEERING COMPANY INC., Chester, CT (US)

(21) Appl. No.: 18/806,271

(22) Filed: Aug. 15, 2024

(51) Int. Cl. B60Q 1/26; B60Q 5/00

(52) U.S. Cl. CPC B60Q 1/2611; B60Q 5/005; B60Y 2304/05; B60Y 2410/10

(57) ABSTRACT

Systems and methods are directed toward an integrated, compact speaker and light head assembly. Body portions may be coupled to a speaker section to form a lightbar body. The speaker section may include one or more assemblies having openings with an axial height that is greater than adjacent body portion axial heights. The lightbar body may be coupled to one or more mounting locations using fastener apertures extending through portions of the lightbar body.

### TECHNICAL FIELD

At least one embodiment pertains to visual and auditory warning devices. More specifically, at least one embodiment pertains to a lightbar that includes one or more light heads and an integrated siren.

### BACKGROUND

Lightbars may be affixed to various locations, such as vehicles, and used to provide warnings or other notifications. For example, a lightbar on an emergency vehicle may include different light heads that can illuminate and emit light beams, often with different colors and/or patterns, to provide notifications to other vehicle operators. Additionally, auditory warnings may also be included on the emergency vehicles to provide additional indicators to other vehicle operators. Often, the use of warning lights and/or sirens are associated with different regulatory requirements, and as a result, equipment may be large, bulky, and expensive. For example, in order to meet established regulatory requirements, separate sirens may be provided and mounted onto vehicles. As a result, vehicles often include multiple mounting configurations and complex control schemes in order to integrate operation of both the light heads and sirens.

### BRIEF DESCRIPTION OF THE DRAWINGS

Various embodiments in accordance with the present disclosure will be described with reference to the drawings, in which:

FIG. 1 illustrates a perspective view of an embodiment of lightbar, in accordance with at least one embodiment;

FIG. 2 illustrates a front view of an embodiment of a lightbar, in accordance with at least one embodiment;

FIG. 3 illustrates a bottom view of an embodiment of a lightbar, in accordance with at least one embodiment;

FIG. 4 illustrates a bottom perspective view of an embodiment of a lightbar in which a spine component has been removed, in accordance with at least one embodiment;

FIG. 5A illustrates a top perspective view of an embodiment of a lightbar in which a cover has been removed from a siren portion to illustrate an electronics package, in accordance with at least one embodiment;

FIG. 5B illustrates a top perspective view of an embodiment of a lightbar in which a cover has been removed to illustrate a spine assembly, in accordance with at least one embodiment;

FIG. 5C illustrates a bottom perspective view of an embodiment of a lightbar in which frame portions have been removed to illustrate a spine assembly, in accordance with at least one embodiment;

FIG. 6 illustrates a schematic diagram of an embodiment of a control system, in accordance with at least one embodiment;

FIG. 7 illustrates example lightbar configurations, in accordance with at least one embodiment;

FIG. 8A illustrates an exploded top perspective view of an example of a light bar assembly process illustrating a sub-assembly and base assembly, in accordance with at least one embodiment;

FIG. 8B illustrates an exploded top perspective view of an example of a light bar assembly process illustrating a sub-assembly, a base assembly, and a weldment, in accordance with at least one embodiment;

FIG. 8C illustrates an exploded bottom perspective view of an example of a light bar assembly process illustrating a sub-assembly, a base assembly, and a weldment, in accordance with at least one embodiment;

FIG. 8D illustrates an exploded top perspective view of an example of a light bar assembly process, in accordance with at least one embodiment; and

FIG. 8E illustrates an exploded top perspective view of an example of a light bar assembly process illustrating multiple sections coupled to a base assembly, in accordance with at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

Systems and methods of the present disclosure are directed toward a combination lightbar assembly that includes one or more light heads (e.g., light emitters) and an siren (e.g., a speaker, an auditory device, etc.). At least one embodiment includes a low-profile and/or compact design that may integrate electronics associated with the light heads and/or the siren, the siren, and multiple light heads. The lightbar may be installed for use on one or more vehicles, such as emergency vehicles, and may be mounted to different locations of the vehicle. In at least one embodiment, the lightbar may include modular components that can be removed and/or replaced, which may provide improved configuration layouts and also reduce costs associated with maintenance and long-term use. Additionally, the modular design may increase a number of vehicles that may be used with embodiments of the present disclosure.

In at least one embodiment, the lightbar may include one or more electronic components particularly selected to meet and/or exceed one or more regulatory standards (e.g., SAE J595, SAE J845, SAE Classes 1-3 warning lights, etc.). For example, a cross-sectional area for a siren may be particularly selected in order to emit a desired sound or pitch. In another example, one or more electronic components may be tuned or otherwise used in a manner to generate the desired sound (e.g., one or more of frequency, pitch, loudness, timbre, amplitude, duration, rhythm, or intensity) regardless of the dimensions of the siren. Accordingly, systems and methods may be used to integrate one or more sirens, with various potential operating configurations, within a unitary packaging with one or more light heads. The unitary packaging may include associated electronic components to operate the siren and/or the light heads, which may provide an improved package for installation and control with simplified wiring, mounting, and operation.

Embodiments of the present disclosure may address and overcome problems with existing configurations in which lightbars and sirens are provided as independent, separate systems. The existing configurations often lead to awkward mounting scenarios and/or visually displeasing appearances. Furthermore, positioning large, bulky equipment on vehicles reduces fuel and/or battery charge efficiency. Systems and methods address and overcome these problems with an integrated system that is configurable for a wide variety of applications while maintaining compliance with a variety of regulatory standards. For example, embodiments may integrate a siren into a common housing with one or more light heads to reduce protrusions or discontinuities along the lightbar. Similarly, embodiments may maintain compliance with various regulatory standards by modifying speaker operations and/or physically modifying configurations to provide a robust, but compact, electronics package. Various embodiments may also provide various integrated structural features for improved strength and rigidity while also reducing weight and size of the lightbar.

Systems and methods of the present disclosure are directed toward one or more assemblies or sub-assemblies that may be used to form and mount one or more extrusions onto a base component, which may be a vehicle and/or the like. At least one embodiment includes one or more extrusions that may serve as a base or mounting portion to receive one or more sub-assemblies that may incorporate various features, including but not limited to, sirens/horns, lights, and/or the like. In at least one embodiment, the base may be used to provide improved structural rigidity for the assemblies/sub-assemblies while still providing a low-profile assembly that may include a substantially flush top and/or a flush bottom. Various embodiments may incorporate a subframe weldment to provide improved and/or sufficient structural rigidity and/or strength to attached the various sub-assemblies to the base extrusions. The subframe weldment may be extend across at least a portion of the sub-assemblies and then secure to the sub-assemblies and/or to the base extrusion, for example using hardware such as threaded fasteners and/or the like. Systems and methods of the present disclosure may include a recess or mounting region for the subframe weldment that may be defined, at least in part, by one or more portions of the sub-assemblies. For example, one or more portions of the sub-assembly may overlap and/or partially overlap the base extrusion, thereby providing a region to receive and support the subframe weldment. Systems and methods may further include one or more backing plates on an underside of the base extrusion to secure the subframe weldment and/or the one or more sub-assemblies. In this manner, the base extrusion may be split and/or divided while still maintaining support for the overall assembly by using, at least in part, the subframe weldment. Embodiments may further include multiple subframe weldments over multiple different base extrusions in order to couple together a variety of different sub-assemblies.

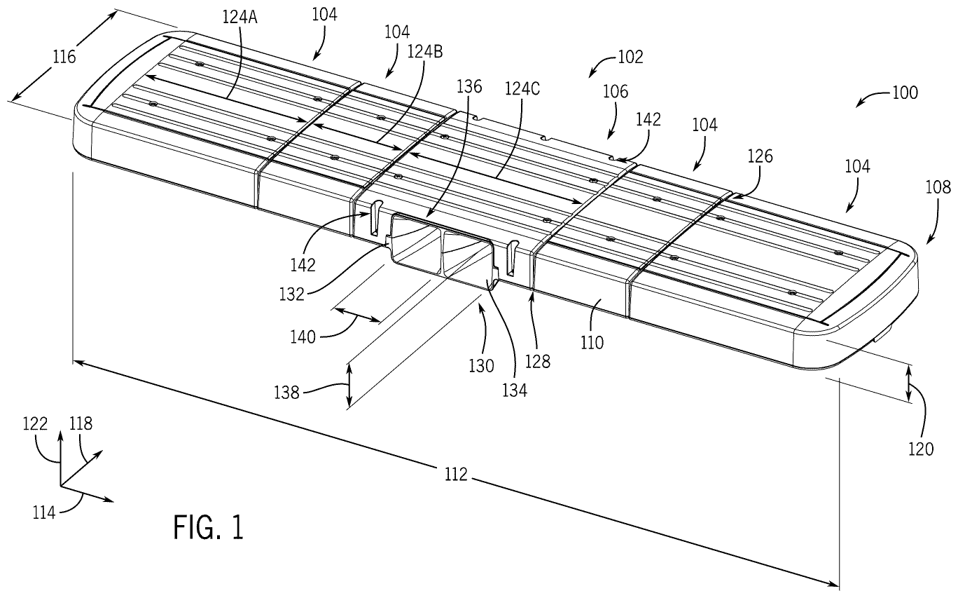

FIG. 1 illustrates a perspective view of an embodiment of a lightbar assembly 100 (e.g., lightbar, assembly, lightbar system, etc.), which may be used with one or more embodiments of the present disclosure. In this example, the lightbar assembly 100 includes a plurality of sections 102. The illustrated sections 102 may include body sections 104, siren sections 106, end caps 108, and/or combinations thereof. Additionally, one or more of the body sections 104, siren sections 106, end caps 108, and/or combinations thereof may include one or more integrated light heads 110. The light heads 110 may include illumination elements, such as light emitting diodes (LEDs) as one non-limiting example, that may be controlled by one or more control systems to emit light responsive to a control signal. In at least one embodiment, sections including the light heads 110 may include transparent or semi-transparent covers. The covers may also be colored or tinted such that the illumination elements may be one color, but when activated, the visual appearance of the emitted light will correspond to the color of the covers. It should be appreciated that multiple light heads may be integrated into individual sections 102 and/or may be provided for a particular use/configuration. For example, one or more regulatory requirements may include standards for colors, light head, light head output, and/or the like. Accordingly, embodiments of the present disclosure may be used to provide light head configurations to meet and/or exceed regulatory standards while also providing a compact, streamlined visual appearance that integrates multiple components within a common housing or carrier.

The illustrated lightbar includes a length 112 (e.g., axial length, a width) along a first axis 114, a depth 116 (e.g., a transverse depth) along a second axis 118, and a height 120 (e.g., a longitudinal length, a thickness) along a third axis 122. In at least one embodiment, respective section lengths may vary, at least in part, based on a desired overall length 112. For example, it may be desirable to have sections 102 that have a common section length 124. However, in other embodiments, such as the embodiment of FIG. 1, it may be desirable to have different section lengths 124 for different sections. In this example, the section length 124A corresponding to a body section is greater than the section length 124B corresponding to another body section. Similarly, the section length 124C corresponding to the siren section 106 is also greater than the section length 124B. Accordingly, systems and methods may be used to modularly assemble different sections 102 having different lengths to create a desired lightbar configuration. For example, certain light heads 110 may be tinted with different colors and it may be desirable to have a certain number of light heads corresponding to a first color be greater than a number of light heads corresponding to a second color. As another example, different sirens may be deployed for different applications, which may lead to different sizes for the siren section 106. Furthermore, one or more embodiments may include multiple siren sections 106.

In this example, transitions 126 are illustrated between the different sections 102, which may include a curved or rounded edge portion 128. It should be appreciated that the edge portion 128 may be squared or angled, and in at least one embodiment, there may be different shapes to the edge portions 128 for different areas of the lightbar 100. Shapes of the transitions 126 may correspond to one or more covers, discussed herein, that may be installed within a recess or space of the sections 102. Furthermore, in this example, the covers are secured to the different sections using one or more mechanical fasteners, but only embodiments may include additional and/or alternative mounting systems, such as press fits, clips, and/or the like. The transitions 126 may facilitate installation and/or removal, for example, to enable positioning one or more removal tools between the different sections 102. One or more fasteners (not illustrated) may be used to connect the different sections 102 together. For example, a press fitting may be used to secure sections 102 together. In another example, internal mechanical fasteners may be used, such as screws. In at least one embodiment, a top cover may be removed to provide access to an interior portion of the lightbar 100. It should be appreciated that one or more sections 102 may be formed from a common housing and/or include a common cover and the transitions 126 may be provided as ornamental or otherwise decorative components. However, in other examples, the transitions 126 may provide regions to permit tooling or other devices to decouple different sections 102 and/or remove a top cover, among other options. In other embodiments, fasteners may be arranged along the top cover for removal to provide access to an interior portion. One or more embodiments may include transparent or semi-transparent top covers in order to permit light from the light heads to illuminate surrounding areas.

The illustrated example of the lightbar 100 includes an integrated siren (e.g., speaker, auditory device, etc.) formed within the siren section 106, which may include a siren assembly 130 having a siren face 132 and a siren body 134. The siren face 132 may be particularly selected such that an opening 136 into the siren body 134 has a particularly selected cross-sectional area. For example, the opening 136 may be sized based, at least in part, on one or more regulatory standards. In this example, the opening 136 is polygonal, such as a square or rectangle, but various other embodiments may include different shapes, such as triangles, circles, ellipses, and/or the like. Additionally, each siren assembly 130 may not have the same opening 136 size and/or shape. For example, different siren assemblies 130 may be integrated into the lightbar 100 with different functions, such as one to emit a siren and another to be used as a speaker. However, it should be appreciated that a common siren assembly 130 and/or assemblies may be used as both sirens and speakers.

In this example, a height 138 of the siren face 132 is larger than the height 120. As a result, a portion of the siren face 132 is illustrated as extending axially lower than the remainder of a front of the lightbar 100. It should be appreciated that such a configuration is provided way of example and that other embodiments may include the height 138 equal to or less than the thickness 120. Furthermore, the height 138 may extend above (e.g., axially higher) in various other embodiments.

FIG. 1 illustrates a pair of siren assemblies 130, but other embodiments may include more or fewer siren assemblies. For example, there may be a single siren assembly 130. As another example, there may be three, four, or any reasonable number of siren assemblies 130. Additionally, there may be multiple siren sections 106 having different numbers of siren assemblies 130. When evaluating the openings 136, the cumulative cross-sectional area may be used to determine whether or not the siren section 106 meets a regulatory standard. For example, a first cross-sectional area for a first assembly may be added to a second cross-sectional area for a second assembly to determine whether or not one or more regulatory standards are satisfied. In this manner, different types of siren assemblies 130 with different dimensions may be used. For example, each siren assembly 130 may not have the same configuration, such as having one siren face 132 with a different height 138 than another. As another example, the siren faces 132 for the siren assemblies 130 may have different widths 140. Accordingly, systems and methods of the present disclosure may implement a variety of different configurations having different numbers of siren assemblies 130 with multiple possible combinations of heights 138, widths 140, and/or geometric configurations (e.g., circulator, square, rectangular, triangular, etc.).

At least one embodiment includes fastener apertures 142 that may extend through a base (not pictured) of the lightbar 100 in order to secure the lightbar 100 to a mounting location, such as a rooftop of a vehicle, among other options. This example includes five fastener apertures 142, with two being on either side of the siren assemblies 130 and three being at a back side opposite the siren assemblies 130. More or fewer fastener apertures 142 may be used with various embodiments, and moreover, may be positioned at different locations, such as near the end caps 108, through the body sections 104, and/or in various other locations.

Systems and methods of the present disclosure may also include one or more ornamental designs associated with the lightbar 100, such as textures and/or the like. The design may further provide a desired light output pattern and/or appearance. For example, different angular locations of a transparent and/or semi-transparent material may reflect light differently, which may be selected to increase awareness of the light, direct the light to a particular area, and/or combinations thereof. Accordingly, systems and methods may incorporate different waves, peaks/valleys, and other techniques to modify/adjust an appearance of the light output of the light heads 110.

As discussed herein, various embodiments may be directed toward a compact, integrated lightbar that includes both light heads and siren assemblies. In at least one embodiment, an overall height of the lightbar may be less than a threshold value, and as a result, may provide an improved appearance, easier installation, and/or a reduced cost for assembly. Furthermore, embodiments may be directed toward modular design configurations that may add and/or remove different sections 102 based on one or more design considerations, such as overall size of the mounting location.

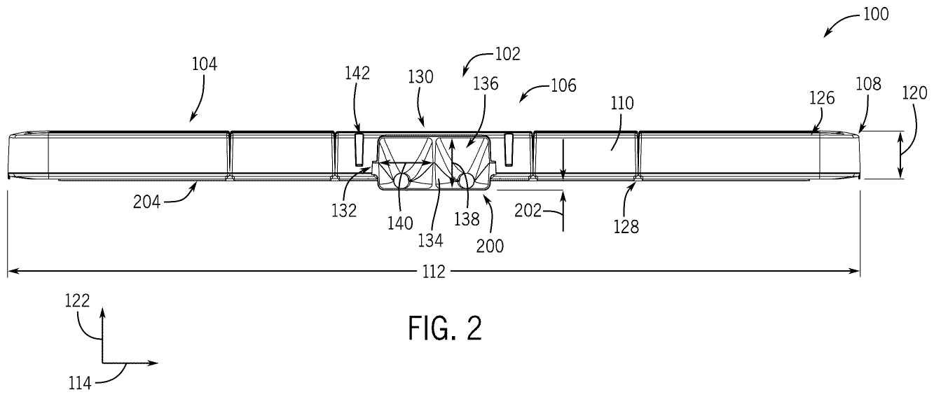

FIG. 2 illustrates a front view of an embodiment of the lightbar 100 that may be used within the scope of the present disclosure. In this example, the configuration of the siren assembly 130 within the siren section 106 illustrates an extension portion 200 that extends for an extension distance 202 axially lower than a base 204 forming at least a portion of the sections 102. In at least one embodiment, one or more portions of the siren assembly 130 may form at least some of the base 204. For example, the siren assembly 130 may include the siren body 134 which may be formed or otherwise incorporated into at least a portion of the base 204. In certain embodiments, the siren body 134 may also be positioned axially lower than one or more portions of the base 204. The siren body 134 may include a sloped or angled portion that converges toward a center point, which may be opposite the siren face 132. Accordingly, one or more embodiments may include portions of the siren body 134 that are incorporated into the base 204 and portions that are axially lower than the base 204.

Further illustrated are the fastener apertures 142, which in this example are positioned on opposite sides of the siren assemblies 130. Two fastener apertures 142 are shown by way of non-limiting example and other embodiments may include more or fewer apertures 142. Furthermore, the apertures 142 may not be formed in the siren section 106 and may be located in one or more body sections 104. The use of the fastener apertures 142 may enable coupling to one or more mounting locations, such as a vehicle. In at least one embodiment, different modular configurations may position the fastener apertures 142 at particularly selected locations to accommodate expected mounting locations such that the apertures 142 align with the mounting locations.

Various embodiments of the present disclosure provide for the compact, substantially planar lightbar assembly 100 illustrated in FIG. 2. As shown, a top surface is substantially planar, providing a sleek appearance while also reducing the height 120. In at least one embodiment, mounting locations where the lightbar 100 is coupled may have a thickness or height that is greater than the extension distance 202, and as a result, the lightbar 100 may be mounted and appear substantially flat along a mounting location, such as a roof. In other words, rails or other mounting fixtures may have a thickness, relative to a top of a mounting location, that is greater than the extension distance 202, thereby permitting the extension axially lower than the base 204 while facilitating coupling and installation of the lightbar 100.

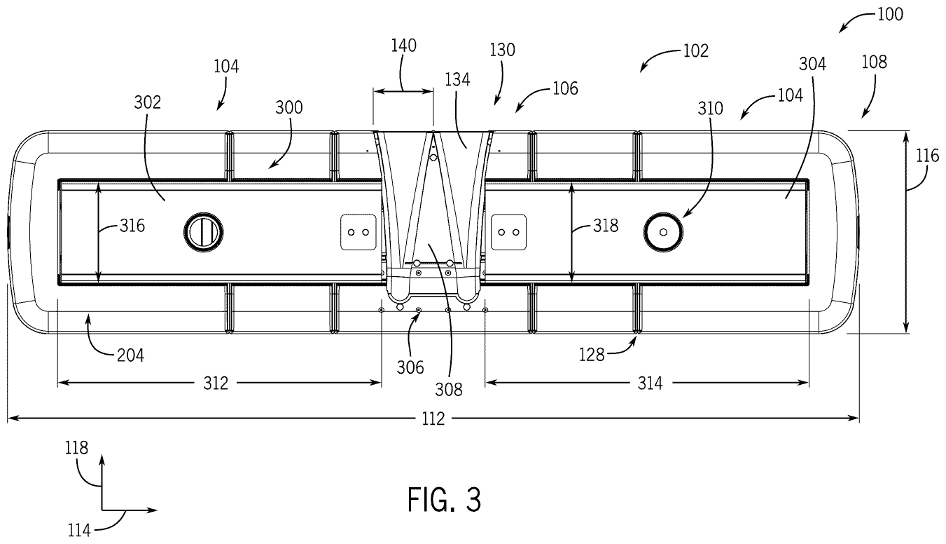

FIG. 3 illustrates a bottom view of an embodiment of the lightbar 100 that may be used with the present disclosure. In this example, the edge portions 128 are illustrated along the bottom of the lightbar 100 between the individual sections 102. As discussed here, the edge portions 128 are provided by way of example and may be omitted and/or modified based on design considerations. In this example, the base 204 may include one or more components that, cumulatively, form a bottom area of the lightbar 100.

In this example, a spine 300 (e.g., extrusion, base sub-assemblies, base extrusion, structural spine, backbone, structural support, etc.) extends along portions of the base 204 as a first spine portion 302 and a second spine portion 304. As discussed herein, the spine 300 may be used to form a structural support that receive and supports the different individual sections 102, thereby providing the structural rigidity necessary for the lightbar 100 while also providing design flexibility to incorporate a variety of different sub-assemblies, such as different sirens/horns, lights, antennas, communication systems, and/or the like. As discussed herein, the spine 300 may be used to couple the remainder of the lightbar 100 to one or more base locations, such as a vehicle and/or the like. In at least one embodiment, splitting the spine 300 into the first pine portion 302 and the second spine portion 304 may reduce rigidity and/or strength of the spine 300, but a subframe weldment (not pictured), as one option may be incorporated in order to improve structural rigidity of the lightbar 100, secure the sub-assemblies to the spine 300, and/or to provide for improved design flexibility while also enabling a low-profile design.

The spine 300 in this example is split and into the two different spine portions 302, 304 and is bisected by the pair of siren assemblies 130, which as discussed herein may form a common sub-assembly. For example, the pair of siren assemblies 130 may be incorporated into a base assembly, such as an electronics package, which may include various electronics, wiring configurations, and/or support members to secure the sub-assembly to the spine portions 302, 304. The siren assemblies are illustrated as part of a unitary auditory system 306 with a common structural support 308. As discussed herein, the common structural support 308 may be used to bridge a gap or open area between the two spine portions 302, 304. However, because the different assemblies are not continuous, there may be reduced structural stiffness and/or strength at the different intersecting areas. Embodiments of the present disclosure address and overcome this problem by incorporating one or more joining features, such as the subframe weldment, to secure the unitary audio system 306 to the spine portions 302, 304. The combination of both the spine 300, the subframe weldment (not pictured), and the additional structural support of the unitary auditory system 306 may provide sufficient strength and rigidity to support the weight of the components that are integrated into the lightbar 100. In this example, the first spine portion 302 extends over portions of two body sections 104 and partially into the siren section 106. Similarly, the second spine portion 304 also extends over portions of two body sections 104 and partially into the siren section 106. This example does not include the spine 300 extending to the end caps 108, but it should be appreciated that alternatives may incorporate portions of the spine 300 into the end caps 108.

In at least one embodiment, the siren body 134 may be incorporated into and/or used to form a portion of the unitary audio system 306. For example, the siren body 134 may form an outer portion and provide at least some of the structural strength associated with the common structural support 308, which in this example, extends between and couples the respective bodies 134 of the siren assemblies 130.

One or more ingress ports 310 may be integrated into the spine 300 for routing of cables for various internal electronics. In at least one embodiment, the ingress ports 310 may be covered by one or more covers or plugs, thereby blocking external material (e.g., dust, water, etc.) from entering the internals of the enclosure. Various embodiments of the present disclosure may use one or both of the ingress ports 310 to route different electronics wiring or hardware between the lightbar 100 and/or more systems of the vehicle associated with the lightbar 100. In this example, the one or more ingress ports 310 include circular features, but it should be appreciated that a variety of other configurations may also be used within the scope of the present disclosure, such as rectangular and/or the like. The relative positions of the ingress ports 310 may be particularly selected based on anticipated mating locations for one or more systems to facilitate mounting the lightbar 100 to a desired location. For example, location of the ingress ports 310 may be selected to reduce a length of wiring used. Systems and methods of the present disclosure may further include a variety of mounting features, which may also be integrated into the spine 300, or which may be otherwise coupled to one or more portions of the lightbar 100. For example, different apertures, fastener systems, and/or the like may be used to secure the lightbar 100 to a desired location and/or to secure one or more portions of the lightbar 100 to one or more other portions of the lightbar 100.

Returning to the spine 300, this example includes portion lengths 312, 314. As shown, the portion lengths 312, 314 are equal to one another, but in various other embodiments one of the portion lengths 312, 314 may be larger than or smaller than the other. In this example, the cumulative length of the portion lengths 312, 314 is less than the length 112 of the lightbar 100. For example, as noted herein, the portion spine portions 302, 304 do not extend entirely across the siren section 106 and also do not extend through the end caps 108, and as a result, the spine 300 only covers a part of the base 204. Various other embodiments may increase or decrease the cumulative length of the spine 300 and/or individual spine lengths 312, 314 based on one or more operating or design conditions. Additionally, it should be appreciated that there may be some overlapping portions. For example, in at least one embodiment, the portions 302, 304 may overlap with parts of the siren body 134 and/or the unitary audio system 306.

In at least one embodiment, the spine 300 and/or portions thereof may be installed within an recess formed within the backs of the individual sections 102. For example, various embodiments may facilitate a modular construction of the lightbar 100 that connects different individual sections 102 together. The sections 102 may include a recessed portion that is configured to receive the spine portions 302, 304, thereby forming the lightbar 100. As discussed herein, the recessed portions may also include different regions to receive and/or support different joining features, such as the subframe weldment. The spine portions 302, 304 may include individual components or features in various embodiments in order to facilitate stacking and/or configuring different numbers together to fit within the space provided by the recesses of the portions 102. Furthermore, in various other embodiments, the spine portions 302, 304 and/or individual portions 102 may be integrally formed together to make the lightbar 100.

The spine portions 302, 304 also include portion depths 316, 318 along the third axis 118. In this example, the depths 316, 318 are less than the depth 116 of the entire lightbar 100. It should be appreciated that the depths 316, 318 may be particularly selected based on one or more design properties and that the depths 316, 318 may not be equal. In one or more embodiments, the depths 316, 318 may also vary along the respective lengths 312, 314, thereby providing additional support at targeted areas compared to other portions. For example, it may be desirable to place additional supports near the siren section 106 to provide sufficient structural support for the electronic components. Accordingly, in at least one embodiment, the depths 316, 318 may be greater proximate the unitary audio system 306 than proximate the end caps 108.

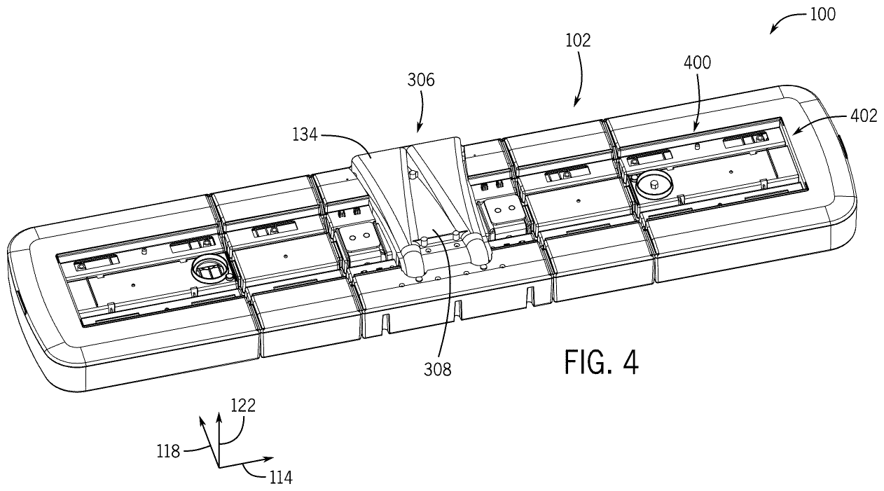

FIG. 4 illustrates a bottom perspective view of an embodiment of the lightbar 100 where the spine 300 has been removed to illustrate recesses 400 within each of the respective sections 102. As discussed herein, providing recesses to receive the spine 300 may facilitate a modular construction that combines as many or as few sections 102 as desired for a particular application. Thereafter, an appropriately sized spine 300 and/or the spine portions 302, 304 may be selected and arranged within the recesses 400 to provide additional structural rigidity to the assembly. Further illustrated in the respective sections 104 are section structural members 402 that may be coupled to the spine 300 (not pictured). Various embodiments discussed herein may include the spine 300 to secure and support the illustrated sections 102, for example, where the spine 300 is received within the respective recesses 400 and/or interacts with the respective structural members 402. In this example, each individual section 102 includes an independent structural member 402, which may be aligned in order to form the lightbar 100. As discussed herein, systems and methods may include one or more subframe weldments to provide structural integrity to the lightbar 100. Accordingly, one or more fasteners or other structures associated with the sub-assemblies, such as the unitary audio system 306, may accommodate reduced loads and/or forces, or may be made of lighter materials, such as plastics and/or the like. In at least one embodiment, systems and methods may include a subframe weldment, straps, multiple weldments, clips, and/or the like to secure the sub-assemblies to the extending spine 300. Accordingly, embodiments may provide a composite design that provides flexibility with the attachments coupled to the spine 300, enabling a mix and match approach that enables any number of lights, sirens, horns, communication systems, and/or the like to be incorporated into the lightbar 100 with a universal attachment between the sub-assemblies and the spine 300 secured, in at least one embodiment, by the subframe weldment. In this manner, systems and methods address and overcome problems with existing configurations that attempt to compile each component into a single package, which reduces flexibility regarding different mounting configurations, component arrangements, and/or the like. Furthermore, systems and methods also provide a flush mount and/or low profile design while maintaining structural integrity, which may be useful to adhere to various manufacturer code requirements and/or desired design constraints. Accordingly, embodiments of the present disclosure provide further design flexibility while maintaining structural integrity and enabling a variety of different use cases and implementations.

Various embodiments of the present disclosure may incorporate one or more weldments or other joining and/or structural features in order to combine one or more extruded portions (e.g., the spine 300) to different assemblies and/or sub-assemblies forming the lightbar 100. In at least one embodiment, systems and methods provide a split or otherwise segmented spine 300, for example into portions 302, 304, that may be used to secure one or more sub-assemblies via one or more joining features, which may include a weldment, straps, clips, and/or combinations thereof. Embodiments further include various receiving areas that may be used to secure the weldment to one or both of the sub-assemblies and/or the spine 300. In this manner, embodiments provide for improved structural rigidity of various components while enabling a smaller, lighter, more compact package.

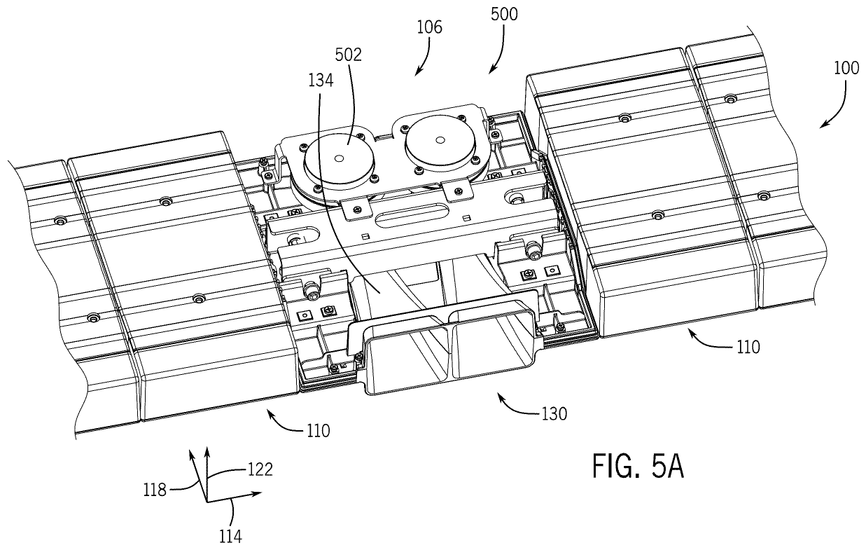

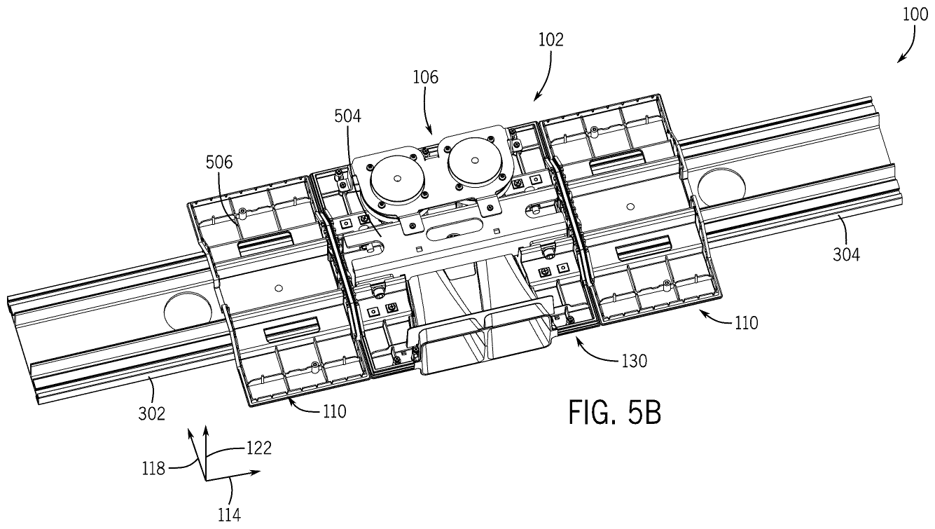

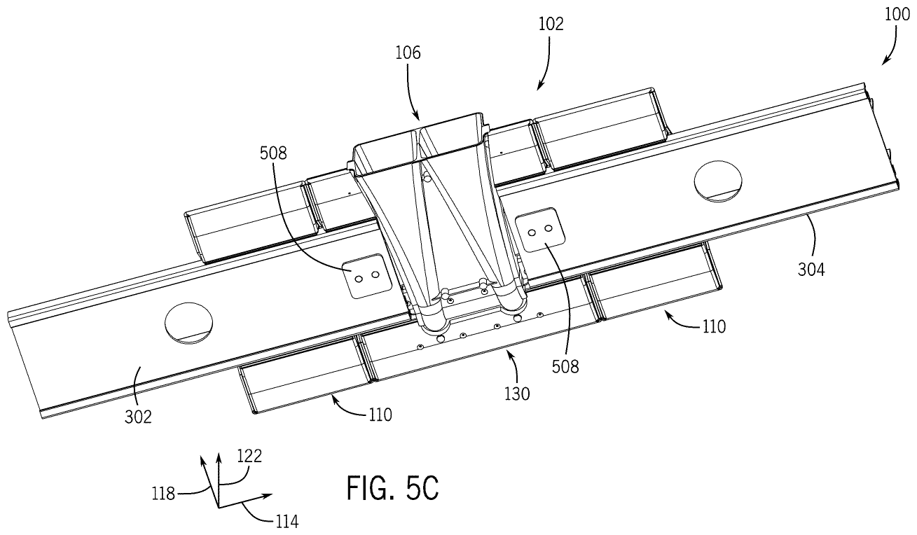

FIG. 5A illustrates a top perspective view of an embodiment of the lightbar 100 where a cover (e.g., the cover 416) and various other components of the siren section 106 have been removed to illustrate an electronics package 500, which may include one or more portions of the unitary audio system 306 discussed herein. As shown, the compact enclosure space of the siren section 106 is configured to provide both structural support and electronics to operate one or more components of the lightbar 100, including the light heads 110 and/or the siren assembly 130. For example, one or more drivers 502 may be used to convert electrical signals into sound waves. As one non-limiting example, the drivers 502 may be 50 W drivers with 12 ohm impedance, but it should be appreciated that various other configurations may be used within the scope of the present disclosure. In at least one embodiment, one or more features of the drivers 502 may be modified in order to fit within the compact, low-profile area provided with the siren section 106. For example, the neck may not be threaded in at least one embodiment.

Various embodiments of the present disclosure further illustrate a weldment 504 (e.g., a joining features, a subframe, a coupling system, etc.) extending across the siren assembly 130 and used to secure the siren assembly 130 of the siren section 106 to the spine 300 (not pictured). As discussed herein, in at least one embodiment, the weldment 504 is used to provide additional structural rigidity to the lightbar 100 by spanning over a gap between the spine 300 formed by the siren assembly 130 positioned between the portions 302, 304 (not pictured). Accordingly, systems and methods of the present disclosure may use the weldment 504 to secure different portions of the lightbar 100 together while still maintaining the compact structure discussed herein.

FIG. 5B illustrates a perspective view of the lightbar 100 further illustrating the weldment 504 coupling the sections 102 to the spine 300. The spine 300 is shown as including both the first and second spine portions 302, 304 extending axially outward from the sections 102. In this example, each of the sections 102 further includes a frame 506, which may be a polymer or other lightweight material, that is used to hold internal electronics or structures (not pictured). As discussed herein, the frames 506 of the respective sections 102 may include recesses 400 to receive the different spine portions 302, 304.

FIG. 5C illustrates a bottom perspective view of the lightbar 100 in which the spine portions 302, 304 are extending across each of the sections 102 and terminate at the siren section 106. While not shown due to the section frame 506 of the siren section 106, the one or more weldments may be used to secure the siren section 106 to the spine portions 302, 304, for example at the connecting regions 508. For example, the weldment may extend across the siren section 106 and into one or more regions in order to engage the spine portions 302, 304 (e.g., at each end of the weldment) to bridge the spacing between the spine portions 302, 304, thereby providing sufficient structural support and rigidity for the lightbar 100.

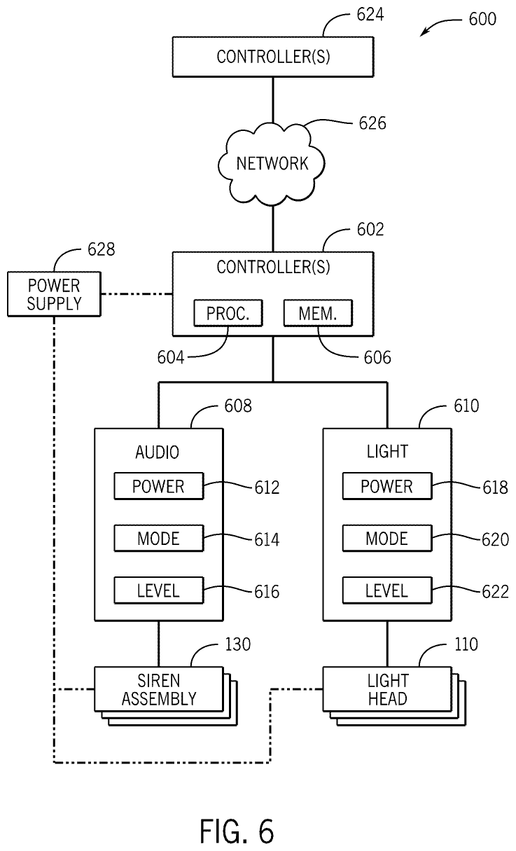

FIG. 6 illustrates a diagram of an embodiment of a control system 600 that may be used with embodiments of the present disclosure. In this example, one or more elements may be shown as being part of or associated with other elements, but it should be appreciated that such description is by way of non-limiting example and that different elements may be remotely located and/or coupled to other elements using one or more wired or wireless connections, among other options. One or more controllers 602 are illustrated for including at least one processor 604 and at least one memory 606.

The processor 604 may include one or more microprocessors, which may include different central processing units (CPUs), graphics processing units (GPUs), data processing units (DPUs), and/or combinations thereof. In at least one embodiment, the processor 604 may be a limited processor or a dedicated processor associated with a system on a chip designed and designated to perform operations associated with the light head. The processor 604 may include a variety of different processors, such as PENTIUM®, Xeon™, Itanium®, XScale™, StrongARM™, Intel® Core™, or Intel® Nervana™ microprocessors available from Intel Corporation of Santa Clara, California, and/or various others. The one or more memories 606 may include a dynamic random access memory (DRAM) device, a static random access memory (SRAM) device, flash memory device, phase-change memory device, or some other memory device.

The one or more controllers 602 may be used to provide instructions to an audio controller 608 and/or a light controller 610. The particular controls of FIG. 6 are shown by way of non-limiting example only and additional and/or alternative controllers may be implemented, for example for GPS receivers/antennas, different communication systems, and/or the like. In at least one embodiment, the instructions may be directed toward the audio controller 608, which may drive one or more operational aspects of the siren assembly. In this example, the control signal may be directed toward a power engine 612, a mode engine 614, and/or a volume engine 616, among various other examples. The power engine 612 may be used to turn the siren assembly 130 on or off, which may be linked to one or more other applications or actions. For example, if the lights are turned on, the siren may automatically be turned on. The mode engine 614 may be used to set a specific mode of operation, such as a certain pattern of sound, a certain tone, and/or the like. For example, the pattern of sound may include a duration of time to wait between different sounds are transmitted from the siren assembly 130. As another example, different modes may include pattens for increasing or decreasing a volume of the siren assembly 130. Similarly, a mode of operation may be associated with a synchronization with other siren assemblies 130, which may be associated with other lightbars.

The instructions may also be associated with the light controller 610 and may also be transmitted to provide operational instructions to one or more of a power engine 618, a mode engine 620, and a level engine 622. The power engine 618 may also control whether or not the lights are on (e.g., emitting light) and may be automatically coupled to one or more other actions. Similarly, the mode engine 620 may be used to select a certain mode of operation, such as a period of time for illumination, a period of time without illumination, a pattern of illumination, synchronization between other lights, and/or the like. Additionally, in at least one embodiment, the level engine 622 may be used to control a brightness of the lights.

The one or more controllers 602 may also operate using a central controller 624, which may be coupled over one or more networks 626. The central controller 624 may be used to transmit a signal to adjust control for multiple lightbars in an area, such as setting each lightbar to operate synchronously, as one example. In operation, responsive to one or more control signals, one or more power supplies 628 may transmit operational energy to the siren assemblies 130 and/or the light heads 110 in accordance to the control signals.

In at least one embodiment, one or more operations of the lightbar may coordinate or otherwise be controlled with one or more additional or nearby lightbars. For example, if the lightbar were operating as a strobe or blinking operational configuration along with others, multiple blinking lights, at different rates, may be distracting to those nearby. Systems and methods may enable coordination such that blinking or strobing or operation of the siren assemblies 130 is synchronized between different lightbars within an area or associated with the same controller. Lightbars on the same vehicle may be synchronized or otherwise controlled to coordinate their flash patterns. And, lightbars on multiple vehicles may be coordinated or synchronized together. This may be done by including a communication interface associated with each lightbar that connects the lightbar to a controller. Further, more than one controller can be included and may be associated with multiple emergency vehicles. The communication interfaces can be wired or wireless interfaces. Wired interfaces may include, for example, CAN buses, wires, or cables. Wireless interfaces may include, for example, wide area network (WAN) interfaces, local area network (LAN) interfaces, cellular communications, WiFi, or radio frequency communications.

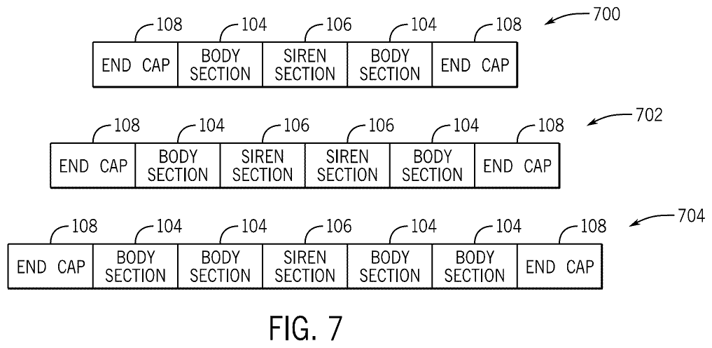

FIG. 7 illustrates example lightbar configurations 700, 702, 704 that maybe used with embodiments of the present disclosure. As discussed herein, one or more portions of the lightbars 700, 702, 704 may be modular components to facilitate construction and generation of different lightbar configurations based on design conditions. In this example, the lightbar 700 includes a configuration including the siren section 106 at the center being surrounded by body sections 104 and end caps 108. In contrast, the lightbar 702 includes two siren sections 106. As another example, the lightbar 704 includes two body sections 104 on each side of the sire section 106. Accordingly, systems and methods may be used to provide interchangeable parts that may be used with various different covers and/or spines in order to provide structural rigidity and protection during operation while incorporating various electronic components within a compact package.

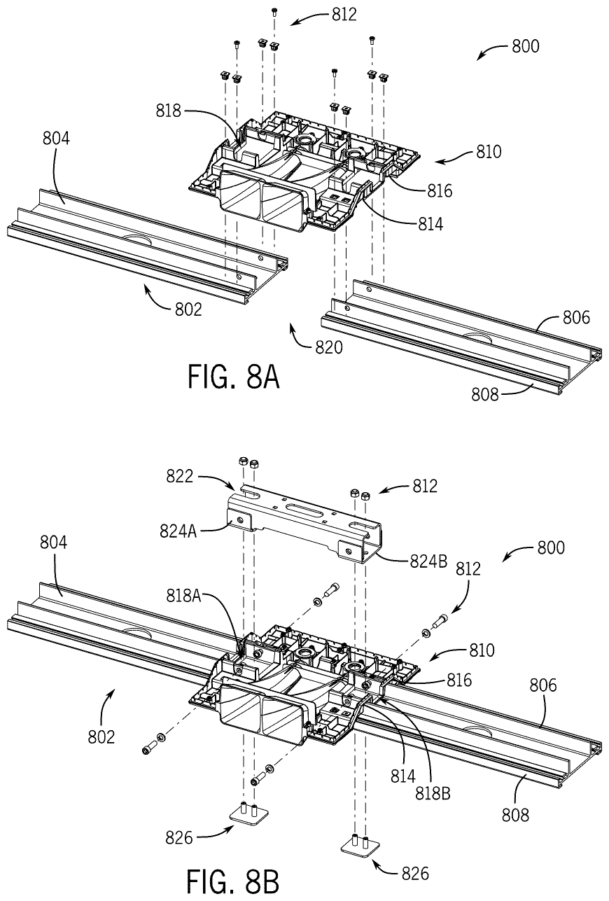

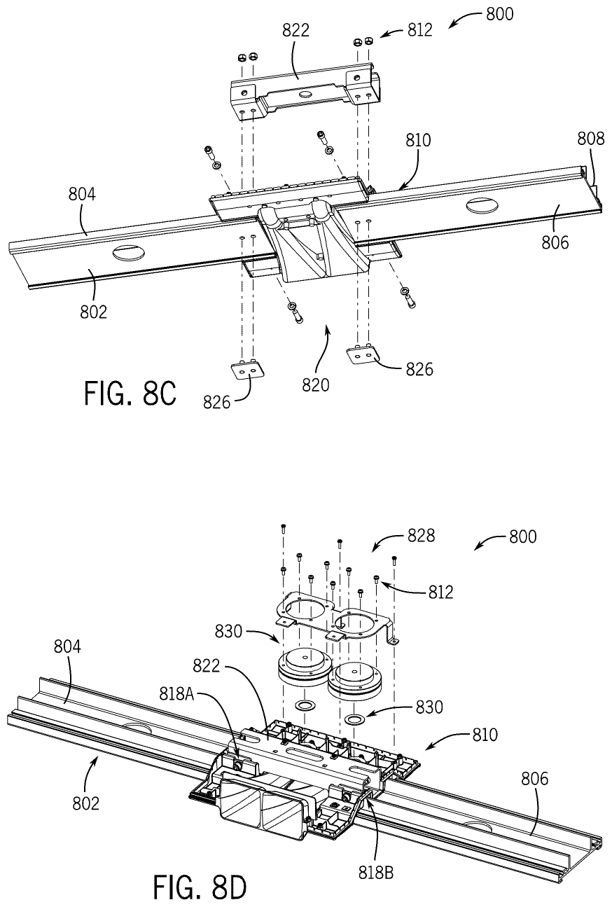

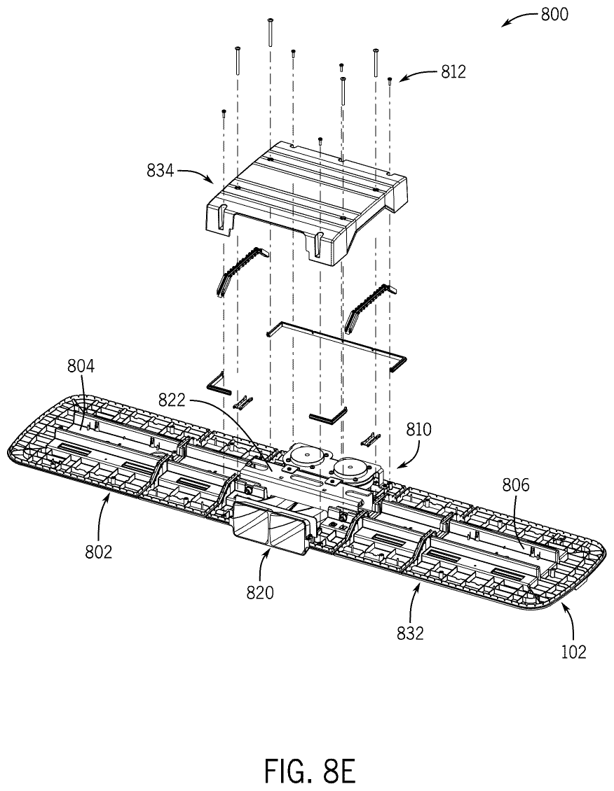

FIGS. 8A-8X illustrate a set 800 of assembly schematics that may be used with embodiments of the present disclosure. It should be appreciated that various features may be omitted for clarity. Furthermore, in at least one embodiment, certain structures used in the assembly, such as particular fittings, fasteners, and/or the like, are provided by way of non-limiting example for simplicity with the present disclosure. FIG. 8A illustrates an exploded view of a portion of a lightbar assembly that includes a base assembly 802 having a first base segment 804 and a second base segment 806, which may correspond to the spine 300 and the respective spine portions 302, 304. The illustrated base assembly 802 is split or otherwise divided and includes rails 808 that may be particularly configured to receive and support one or more connecting sub-assemblies 810, which in this example includes a siren assembly, such as the siren assembly 130.

As shown in this example, the sub-assembly 810 includes a series of different apertures for one or more fasteners 812 to secure the sub-assembly 810 to one or more regions of the base assembly 802, for example associated with various mating apertures. Additionally, the sub-assembly 810 includes peak regions 814, 816 at front and back sides and a recess 818, which as discussed herein, may receive and support one or more portions of a joining features, such as a weldment. In operation, as the sub-assembly 810 is lowered onto the base assembly 802, the peak regions 814, 816 may be supported by or otherwise be positioned over the rails 808 to secure or otherwise couple the sub-assembly 810 to the base assembly 802. As a result, further downward axial movement of the sub-assembly 810, with respect to the base assembly 802, may be blocked by contact between the peak regions 814, 816 and the rails 808.

FIG. 8B illustrates a subsequent step in the assembly process in which the sub-assembly is positioned onto the base assembly 802 such that a first recess 818A is arranged over the first base segment 804 and a second recess 818B is arranged over the second base segment 806. Furthermore, additional fasteners 812 are also illustrated, which include fasteners that may be used for vertical engagement and/or horizonal engagement with respect to a variety of apertures and mating apertures of the sub-assembly 810 and/or the base assembly 802.

As shown in FIG. 8B, the sub-assembly 810 has filled an opening or space 820 formed between the base segments 804, 806. However, the various fasteners and/or features of the sub-assembly 810 may include plastic or other lightweight components that may not have the same structural rigidity and/or strength as the base assembly 802, which may be formed from a metal (e.g., aluminum, steel, etc.), a composite, or any other reasonable material. Accordingly, systems and methods of the present disclosure may incorporate one or more joining structures 822, which may also be referred to as a weldment) that may extend across at least a portion of the sub-assembly 810 and be secured to the base assembly 802, for example at the recesses 818.

In at least one embodiment, the joining structure 822 may be formed from a material having particularly selected strength and/or rigidity in order to facilitate coupling the two base segments 804, 806 together while further incorporating the sub-assembly 810 into the overall composition. In at least one embodiment, ends 824A, 824B of the joining structure 822 are arranged to engage respective recesses 818A, 818B, for example using one or more fasteners, such that the overall assembly is stiffened by the joining structure 822. The joining structure 822 may be used with a variety of different sub-assemblies 810, thereby providing improved flexibility and options with respect to forming an overall assembly, which may include different sub-assemblies 810 such as lights, sirens/horns, GPS antennas, communication systems, and/or the like.

Further illustrated as coupling members 826 that may be secured to an underside of the respective segments 804, 806, for example at opposite sides of the recesses 818A, 818B to receive the one or more fasteners 812 to secure the joining structure 822 to the segments 804, 806. In this manner, the two segments 804, 806 may be secured together on opposite sides of the sub-assembly 810, which may permit improved structural rigidity of the overall system while also enabling a small, compact electronics package associated with the sub-assembly 810.

FIG. 8C illustrates a bottom perspective view of the step shown in FIG. 8B in the assembly process in which the sub-assembly 810 is positioned onto the base assembly 802. In this example, the opening 820 is visible in which the sub-assembly 810 is extending and spanning between the portions 804, 806. In operation, as shown by the dashed lines, the joining structure 822 may be positioned onto the portions 804, 806 and then the coupling members 826 may be used to further secure the joining structure 822 to the portions 804, 806, for example, via one or more fasteners 812.

FIG. 8D illustrates a further step in the assembly process in which the joining structure 822 is secured to the portions 804, 806 and a speaker assembly 828 is assembled as part of the sub-assembly 810. As shown in this configuration, the joining structure 822 is secured to each of the portions 804, 806 within the recesses 818, thereby forming a structurally rigid assembly between the portions 804, 806 and the sub-assembly 810. Such a configuration provides further spacing for the components 830 of the speaker assembly 828, such as a gasket, driver, bracket, and/or the like.

FIG. 8E illustrates an additional step in the assembly process in which additional frame portions 832 for each of the sections 102 are coupled to the segments 802, 804 and a top cover 834 is arranged to cover the sub-assembly 810. In this example, the opening 820 is filled by the sub-assembly 810, which further includes the respective frame portion 832, which may be secured below the segments 802, 804. Additionally, as discussed herein, one or more embodiments may include multiple different segments 102, which may each include respective frame portions 832. In this manner, different configurations may be assembled using the base assembly 802 to provide structural rigidity and support for the assembly as a whole.

Embodiments of the present disclosure may also be described in view of the following clauses:
1. A lightbar assembly, comprising:
one or more body sections including one or more light heads, the one or more body sections including a cover over a top portion and an interior structural member;
one or more siren sections including one or more siren assemblies, the one or more siren sections being arranged adjacent to at least one of the one or more body sections, wherein the one or more siren sections including an electronics package formed within an interior portion including at least audio electronics for generating one or more audio outputs responsive to a control signal;
a pair of end caps arranged at opposite ends of the lightbar assembly, wherein at least one end cap of the pair of endcaps is arranged adjacent to at least one body section of the one or more body sections;
a spine support arranged along a bottom side of the lightbar assembly, the spine support being split by the one or more siren sections; and
a joining member extending across at least one siren section of the one or more siren sections to couple to each of a first spine support segment and a second spine support segment.
2. The lightbar assembly of clause 1, wherein at least a first region of the first spine portion segment and at least a second region of the second spine portion segment overlaps at least a portion of the one or more siren sections.
3. The lightbar assembly of clause 1, further comprising:
a rail forming at least a portion of the spine support; and
a recess formed in a body of the at least one siren section, the recess including an opening to receive an end of the joining member.
4. The lightbar assembly of clause 1, wherein the one or more siren assemblies includes a pair of siren assemblies, and the one or more siren sections further comprise:
a common structural support extending between the pair of siren assemblies.
5. The lightbar assembly of clause 1, further comprising:
a control system configured to transmit the control signal to the audio electronics and to transmit a light control signal to the one or more light heads.
6. The lightbar assembly of clause 1, wherein a siren of the one or more siren assemblies includes an opening with a cross-sectional area exceeding a threshold.
7. The lightbar assembly of clause 1, wherein an overall thickness of the lightbar assembly is less than a threshold.
8. The lightbar assembly of clause 7, wherein a siren height is greater than a body section thickness of the one or more body sections.
9. The lightbar assembly of clause 7, further comprising:
one or more assembly fasteners configured to mount the lightbar assembly to a mounting location, the one or more assembly fasteners extending through at least one siren section of the one or more siren sections.
10. A lighting and auditory system, comprising:
a first body section including a first cover, a first bottom recess, a first light head, and a first support member;
a second body section including a second cover, a second bottom recess, a second light head, and a second support member;
a siren section including a third cover and a siren assembly;
a spine extending along a bottom side of the lighting and auditory system, the spine including first spine portion arranged within the first bottom recess and a second spine portion arranged within the second bottom recess; and
a weldment within a volume of the siren section, a first end of the weldment being coupled to the first spine portion and a second end of the weldment being coupled to the second spine portion;
wherein at least a portion of the siren assembly extends axially lower than the spine.
11. The lighting and auditory system of clause 10, wherein the first spine section overlaps at least a portion of the siren section.
12. The lighting and auditory system of clause 10, wherein the second spine section overlaps at least a portion of the siren section.
13. The lighting and auditory system of clause 10, wherein the siren section bisects the spine.
14. The lighting and auditory system of clause 10, wherein the siren section is coupled to the first body section at a first end and to the second body section at a second end, further comprising:
a first end cap including a third light head coupled to the first body section opposite the siren section; and
a second end cap including a fourth light head coupled to the second body section opposite the siren section.
15. The lighting and auditory system of clause 10, further comprising:
a control system configured to control the first light head, the second light head, and the siren assembly.
16. The lighting and auditory system of clause 10, wherein a cross-sectional opening area of the siren assembly exceeds a threshold.
17. A lightbar assembly, comprising:
a first illumination, section, comprising:
   a first body structure;
   a first cover positioned within a first top recess at a first top side of the first body structure;
   a first support element formed within the first body structure; and
   one or more first light heads;
a second illumination section, comprising:
   a second body structure;
   a second cover positioned within a second top recess at a second top side of the first body structure;
   a second support element formed within the second body structure; and
   one or more second light heads;
an auditory section, comprising:
   one or more siren assemblies;
   an auditory section structural support;
   a first bottom recess;
   a second bottom recess; and
   an electronics package including one or more control systems configured to transmit control signals to at least one of the one or more siren assemblies, the one or more first light heads, or the one or more second light heads; and
a support system, comprising:
   a first spine member, positioned within the first bottom recess;
   a second spine member, positioned within the second bottom recess; and
   a joining member extending across the auditory section from the first bottom recess to the second bottom recess configured to couple the auditory section to the first spine member and to the second spine member.
18. The lightbar assembly of clause 14, wherein the first illumination section is coupled to a first side of the auditory section and the second illumination section is coupled to a second side of the auditory section.
19. The lightbar assembly of clause 14, wherein a first height of the one or more siren assemblies is greater than a second height of the first body structure.
20. The lightbar assembly of clause 14, wherein at least a portion of the first spine member overlaps the auditory section and at least a portion of the second spine member overlaps the auditory section.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A lightbar assembly, comprising:
one or more body sections including one or more light heads, the one or more body sections including a cover over a top portion and an interior structural member;
one or more siren sections including one or more siren assemblies, the one or more siren sections being arranged adjacent to at least one of the one or more body sections, wherein the one or more siren sections including an electronics package formed within an interior portion including at least audio electronics for generating one or more audio outputs responsive to a control signal;
a pair of end caps arranged at opposite ends of the lightbar assembly, wherein at least one end cap of the pair of endcaps is arranged adjacent to at least one body section of the one or more body sections;
a spine support arranged along a bottom side of the lightbar assembly, the spine support being split by the one or more siren sections; and
a joining member extending across at least one siren section of the one or more siren sections to couple to each of a first spine support segment and a second spine support segment.

2. The lightbar assembly of claim 1, wherein at least a first region of the first spine portion segment and at least a second region of the second spine portion segment overlaps at least a portion of the one or more siren sections.

3. The lightbar assembly of claim 1, further comprising:
a rail forming at least a portion of the spine support; and
a recess formed in a body of the at least one siren section, the recess including an opening to receive an end of the joining member.

4. The lightbar assembly of claim 1, wherein the one or more siren assemblies includes a pair of siren assemblies, and the one or more siren sections further comprise:
a common structural support extending between the pair of siren assemblies.

5. The lightbar assembly of claim 1, further comprising:
a control system configured to transmit the control signal to the audio electronics and to transmit a light control signal to the one or more light heads.

6. The lightbar assembly of claim 1, wherein a siren of the one or more siren assemblies includes an opening with a cross-sectional area exceeding a threshold.

7. The lightbar assembly of claim 1, wherein an overall thickness of the lightbar assembly is less than a threshold.

8. The lightbar assembly of claim 7, wherein a siren height is greater than a body section thickness of the one or more body sections.

9. The lightbar assembly of claim 7, further comprising:
one or more assembly fasteners configured to mount the lightbar assembly to a mounting location, the one or more assembly fasteners extending through at least one siren section of the one or more siren sections.

10. A lighting and auditory system, comprising:
a first body section including a first cover, a first bottom recess, a first light head, and a first support member;
a second body section including a second cover, a second bottom recess, a second light head, and a second support member;
a siren section including a third cover and a siren assembly;
a spine extending along a bottom side of the lighting and auditory system, the spine including first spine portion arranged within the first bottom recess and a second spine portion arranged within the second bottom recess; and
a weldment within a volume of the siren section, a first end of the weldment being coupled to the first spine portion and a second end of the weldment being coupled to the second spine portion;
wherein at least a portion of the siren assembly extends axially lower than the spine.

11. The lighting and auditory system of claim 10, wherein the first spine section overlaps at least a portion of the siren section.

12. The lighting and auditory system of claim 10, wherein the second spine section overlaps at least a portion of the siren section.

13. The lighting and auditory system of claim 10, wherein the siren section bisects the spine.

14. The lighting and auditory system of claim 10, wherein the siren section is coupled to the first body section at a first end and to the second body section at a second end, further comprising:
a first end cap including a third light head coupled to the first body section opposite the siren section; and
a second end cap including a fourth light head coupled to the second body section opposite the siren section.

15. The lighting and auditory system of claim 10, further comprising:
a control system configured to control the first light head, the second light head, and the siren assembly.

16. The lighting and auditory system of claim 10, wherein a cross-sectional opening area of the siren assembly exceeds a threshold.

17. A lightbar assembly, comprising:
a first illumination, section, comprising:
a first body structure;
a first cover positioned within a first top recess at a first top side of the first body structure;
a first support element formed within the first body structure; and
one or more first light heads;
a second illumination section, comprising:
a second body structure;
a second cover positioned within a second top recess at a second top side of the first body structure;
a second support element formed within the second body structure; and
one or more second light heads;
an auditory section, comprising:
one or more siren assemblies;
an auditory section structural support;
a first bottom recess;
a second bottom recess; and
an electronics package including one or more control systems configured to transmit control signals to at least one of the one or more siren assemblies, the one or more first light heads, or the one or more second light heads; and
a support system, comprising:
a first spine member, positioned within the first bottom recess;
a second spine member, positioned within the second bottom recess; and
a joining member extending across the auditory section from the first bottom recess to the second bottom recess configured to couple the auditory section to the first spine member and to the second spine member.

18. The lightbar assembly of claim 14, wherein the first illumination section is coupled to a first side of the auditory section and the second illumination section is coupled to a second side of the auditory section.

19. The lightbar assembly of claim 14, wherein a first height of the one or more siren assemblies is greater than a second height of the first body structure.

20. The lightbar assembly of claim 14, wherein at least a portion of the first spine member overlaps the auditory section and at least a portion of the second spine member overlaps the auditory section.
